(19) United States
(12) Patent Application Publication
(10) Pub. No.: US 2026/0084575 A1
(43) Pub. Date: Mar. 26, 2026

(54) SYSTEM AND METHOD FOR PERFORMING CHARGING DIAGNOSTICS AT A CHARGE DEPOT THROUGH SCHEDULING

(71) Applicant: Ford Global Technologies, LLC, Dearborn, MI (US)

(72) Inventors: Stuart C. Salter, White Lake, MI (US); Kristen Johnson, Ann Arbor, MI (US); Peter J. Nikolajevs, Dearborn, MI (US); Ryan O'Gorman, Beverly Hills, MI (US); Annette Lynn Huebner, Highland, MI (US)

(21) Appl. No.: 18/893,235

(22) Filed: Sep. 23, 2024

(51) Int. Cl. B60L 53/67; B60L 53/62; B60L 53/68

(52) U.S. Cl. CPC B60L 53/67; B60L 53/62; B60L 53/68; B60L 2240/70

(57) ABSTRACT

A control system controls a charge operation of an electric vehicle (EV) using a plurality of electric vehicle supply equipment (EVSEs). The control system includes a processor programmed to generate a first charge message to assign a first EVSE to perform a charge operation for the EV, and generate a second charge message to assign a second EVSE to perform the charge operation for the EV such that the second EVSE performs the charge operation in response to the first EVSE being unsuccessful in charging the EV after a plug-in attempt by an operator and a previous charge operation having an unsuccessful charge with an operation combination including the operator, the EV, or the first EVSE.

### TECHNICAL FIELD

The present disclosure is generally directed towards a system or method for controlling charge operations in a charge depot having multiple electric vehicle supply equipment to charge electric vehicles.

### BACKGROUND

Electric vehicles (EVs), such as plug-in hybrid or fully EVs, generally use an electric vehicle supply equipment (EVSE) to charge a battery pack of the EV. Charge depots provide multiple EVSEs that are available for charging EVs, and in some instances, have trained operators to manage and facilitate the charging of the EV. For example, for the charge operation, the operator connects an EVSE connector of the EVSE to a charge port of the EV and may then leave the EV to perform other duties.

### SUMMARY

In one form, the present disclosure, a control system for controlling charge operation of an electric vehicle (EV) using a plurality of electric vehicle supply equipment (EVSEs). The control system includes a processor programmed to generate a first charge message to assign a first EVSE to perform a charge operation for the EV, and generate a second charge message to assign a second EVSE to perform the charge operation for the EV such that the second EVSE performs the charge operation in response to the first EVSE being unsuccessful in charging the EV after a plug-in attempt by an operator and a previous charge operation having an unsuccessful charge with an operation combination including the operator, the EV, or the first EVSE.

In one form, the present disclosure is directed to a non-transitory computer-readable storage medium comprising programming instructions that are configured to cause a processor to control charge operation of an electric vehicle (EV) in a charge depot. The programming instructions includes instructions to instruct a second electric vehicle supply equipment (EVSE) to perform a charge operation for the EV in response to a first EVSE being unsuccessful in charging the EV and an operator having an unsuccessful charge operation associated with the first EVSE, the first EVSE having an unsuccessful charge operation associated with the EV, or the operator having an unsuccessful charge operation associated with the EV.

In one form, the present disclosure is directed to a method for controlling a charge operation of an electric vehicle (EV) at a charge depot having a plurality of electric vehicle supply equipment (EVSEs). The method including transmitting a first charge message to assign a first EVSE to perform a charge operation for the EV, and transmitting a second charge message to assign a second EVSE to perform the charge operation for the EV such that the second EVSE performs the charge operation in response to the first EVSE being unsuccessful in charging the EV after a plug-in attempt by an operator and a previous charge operation having an unsuccessful charge operation associated with the EV or first EVSE, or the first EVSE having an unsuccessful charge operation associated with the EV.

### BRIEF DESCRIPTION OF THE DRAWINGS

FIG. 1 illustrates a charge depot for charging electric vehicles.

FIG. 2 is an example block diagram of a fully electric vehicle.

FIG. 3 is an example block diagram of an EVSE.

FIG. 4 is an example block diagram of a depot control system for the charge depot.

FIG. 5 is a flowchart of an example charge error diagnosis routine.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A charge depot is configured to charge multiple EVs at once using multiple EVSEs, and aim for a first plug-in success of the EVSE to the EV to reduce time and resources spent trouble shooting charging issues or rescheduling charging events. First plug success can be intermittent, and this solution goes beyond only identifying potential hardware issues (e.g., issues of hardware of the EVSE or the EV) and can extend to issues related to a combination of hardware and human operation (e.g., actions of the operator).

In one form, the present disclosure is directed to a system and/or method for identifying potential causes of a plug-in error and scheduling charge operation for the EV in view of previous charge operations. In a non-limiting example, the system/method of the present disclosure is configured to generate a first charge message to assign a first EVSE to perform a charge operation for an EV. In some applications, the first EVSE is selected using a historical charge operation record that indicates successful and/or unsuccessful charge operations and identifies the operator, the EV, and the EVSE taking part in the charge operation. The system/method is further configured to generate a second charge message to assign a second EVSE to perform the charge operation for the EV in response to the first EVSE being unsuccessful in charging the EV after a plug-in attempt by the operator and at least one previous charge operation having an unsuccessful charge with an operation combination including at least two of the operator, the EV, or the first EVSE. That is, the system/method evaluates previous unsuccessful charge operations related to the first EVSE, the EV, and the operator to determine a potential cause of the plug-in error and provide further instructions to advance charging of the EV.

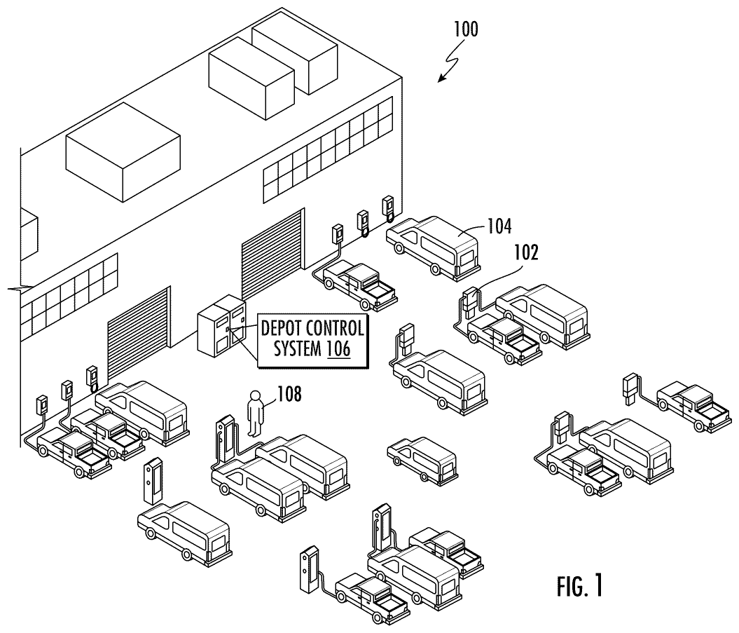

Referring to FIG. 1, a charge depot 100 includes a plurality of electric vehicle supplying equipment (EVSE) 102 for charging multiple electric vehicles (EV) 104. In some aspects, the charge depot 100 includes a depot control system 106 that is configured to schedule charge operations of a selected EV 104 with assistance of an operator 108. In a non-limiting example, the depot control system 106 obtains information related to the EV 104, such as, but not limited to, identification and state of charge. Using the information, the depot control system 106 assigns the EV 104 to a selected EVSE 102 and the operator 108 connects the EVSE 102 to the EV 104.

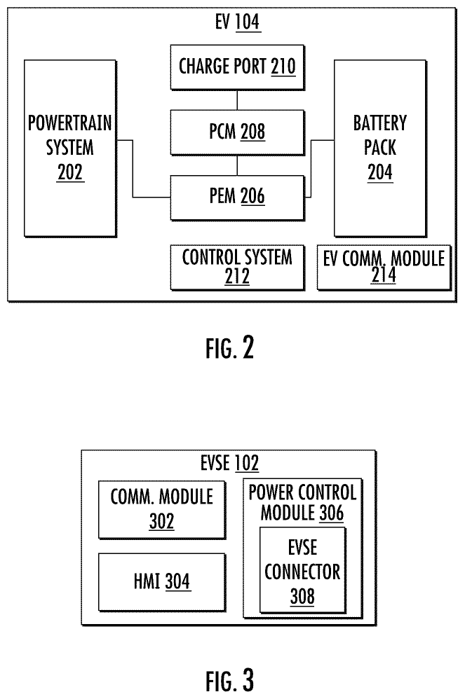

The EV 106 may be a fully-electric vehicle, a plug-in hybrid vehicle, or any other vehicle having a battery pack 204 that can be recharged using the EVSE 102. In a non-limiting example, referring to FIG. 2, the EV 106 includes a powertrain system 202, a battery pack 204, and a power electronics module (PEM) 206. The EV 106 of the present disclosure does not include an engine, and thus, the battery pack 204 provides all of the propulsion power.

The powertrain system 202 includes electric machines (not shown) that provide power movement of the EV 106 via a transmission system. The battery pack 204 provides a high-voltage (HV) direct current (DC) output that is employed to drive the powertrain system 202 via the PEM 206. In one form, the PEM 206, which includes an inverter, provides a bidirectional transfer energy between the battery pack 204 and the electric machines of the power train.

The EV 104 may further include a power conversion module (PCM) 208 that is an on-board charger having a DC/DC converter to condition power supplied from an external power source (e.g., the power grid/network) via a charge port 210, and provide the proper voltage and current levels to the battery pack 204. The charge port 210 is configured to connect to the EVSE 102, which draws power from a power source and supplies it to the EV 104 through the charge port 210 and the PCM 208. In a non-limiting example, the charge port 210 is configured in accordance with a defined protocol such as, Type 1-SAE J1772, Type 2-Mennekes, CHAdeMO, or combined charging system.

In one form, the EV 104 includes a control system 212 to coordinate the operation of the various components. The control system 212 includes electronics and software to perform the necessary control functions for operating the EV 104. The control system 212 may be a combination vehicle control system and powertrain control module (VSC/PCM). In one form, the control system 212 is configured to control operation of the battery pack 204 (e.g., control charging/discharging of the battery pack 204), using for example a state of charge (SOC) or a power limit defined using the SOC of the battery pack 204. In a non-limiting example, during drive operation, the control system 212 determines how much power to draw from the battery pack 204, and during a charge operation, the control system 212 determines how much power is needed to charge the battery pack 204.

Although the control system 212 is shown as a single device, the control system 212 may include multiple controllers in the form of multiple hardware devices, or multiple software controllers with one or more hardware devices. In this regard, a reference to a “controller” herein may refer to one or more controllers.

In addition to components/system for controlling propulsion of the EV 106, the EV 106 also includes other systems for performing other supportive functions. In a non-limiting example, the EV 106 includes a communication module 214 (also referred to as “EV comm. module) that is configured to exchange information with external devices or systems using wired/wireless communication (e.g., BLUETOOTH, ultra-wide band, cellular, and/or WIFI). In one form, the communication module 214 exchanges messages with depot control system 106 and/or the EVSE 102. Accordingly, the communication module 214 may include communication devices like a router, a modem, an antenna(s), an input-output interface, a universal serial bus (USB) port, and/or other suitable devices for supporting wireless and wired communication.

The EVSEs 102 of the charge depot 100 may be of the same type or may be of different type to provide charging to EVs having different charge ports. Referring to FIG. 3, in one form, the EVSE 102 is configured to include a communication (Comm.) module 302, a human machine interface (HMI) 304, a power control module 306, and an EVSE connector 308 to connect to the charge port 210 of the EV 104.

The communication module 302 is configured to communicably couple the EVSE 102 to the depot control system 106, the EV 104, and/or other devices/systems using wired or wireless communication networks supported by one or more wireless communication protocols. In a non-limiting example, the communication module 302 may employ wireless communication protocols such as: Wi-Fi, cellular, BLUETOOTH, and/or ultra-wideband (UWB)), and may include communication devices such as, but not limited to, antenna, transceiver, router, and/or software protocols executed by a processor.

The HMI 304 is configured provide information to a user, such as the operator 108, regarding the charge operation being performed and also, receive input from the operator 108. In a non-limiting example, the HMI 304 includes a touchscreen display, one or more buttons, speakers, and/or microphone. In some aspects, the HMI 304 is configured to provide information provided by the EVSE 102 itself or may provide information from the depot control system 106. For example, the EVSE 102 may indicate if the charge operation is active. In another example, the depot control system 106 provides notification or request additional information using the HMI 304 such as, but not limited to: requesting the operator 108 to provide identification information for the charge operation, providing a notification the EV 104 is to be charged at another EVSE 102, and/or providing instructions on how to connect the EVSE connector 308 to the EV 104.

The power control module 306 is configured to manage transfer of electrical energy between an external power source (e.g., power grid) and the EV 104. Among other electrical devices, such as power inverter and DC-DC converter, the power control module 306 includes the EVSE connector 308 for connecting to the EV 104. In some aspects, the EVSE 102 communicates with the EV 104 using physical communication ports at the EVSE connector 308 of the EVSE 102 and the charge port 210 of the EV 106 (e.g., control pilot) to exchange information related to the charge operation, such as, but not limited to, SOC of the battery pack 204.

In an example operation for charging the EV 104, the operator 108 and a selected EVSE 102 receive instructions to perform a charge operation for the EV 104. The operator 108 may sign in to the selected EVSE 102 to confirm that they are to perform the charge operation, thereby associating the charge operation with a unique identifier associated with the operator 108. In a non-limiting example, the operator may sign in by entering an identification code using the HMI 304 of the EVSE 102, scanning RFID card associated with the operator 108, and/or providing a biometric input like a face scan or fingerprint.

Once signed-in, the operator 108 may attempt to connect the EVSE connector 308 to the charge port 210 of the EV 106, and once connected, the EVSE 102 should begin to charge the EV 106. However, in some instances, the EVSE 102 does not charge EV 106, which may be due to the EVSE connector 308 not being properly engaged with the charge port 210. For example, the operator 108 may not have provided sufficient force to connect the EVSE connector 308 to the charge port 210 to engage the pins of the EVSE connector 308 with the ports of the charge port 210. In another example, the EVSE connector 308/the charge port 210 may have a physical feature (e.g., bump or convex surface on EVSE connector 102/the charge port 210) that may interfere with the charge port 210/the EVSE connector 102. If charging does not commence, the EVSE 102 and/or the EV 104 may transmit a message to the depot control system 106 indicating an error in the charging operation, which may be provided as a plug-in error. In addition to the EVSE 102 and/or the EV 104, the operator 108 may notice that power is not being drawn based on the information provided on the HMI 304 of the EVSE 102 or that the EVSE connector 308 is not connected to the charge port 210. Using the HMI 304, the operator 108 informs the depot control system 106 of the error. In some forms, the EVSE 102, the EV 104, and/or the operator 108 may notify the depot control system after the first plug-in attempt so as to reduce delay in charging. As detailed herein, the depot control system 106 is configured determine the potential cause of the plug-in error, and take additional steps to advance charging efforts.

While the operator 108 is described as communicating with the depot control system 106 using the HMI 304 of the EVSE 102, the operator 108 may also communicate using other devices, such as but not limited to, a portable computing device configured to communicate with the depot control system 106.

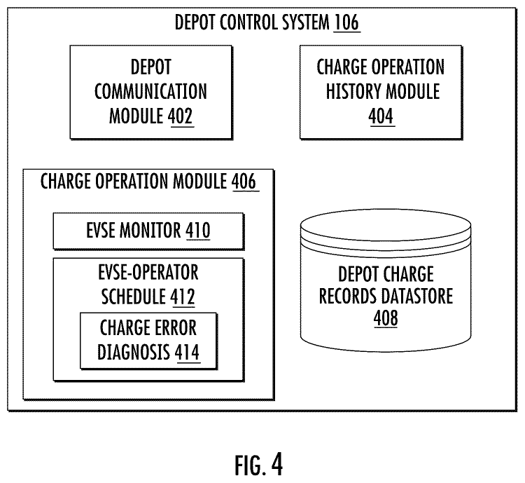

The depot control system 106 is configured to assign EVSE 102 to the EV 104 to be charged using historical information related to the charge operations, where the historical information may include: identification of the EV, the EVSE, and the operator the charge operation; any errors associated with the charge operation, and/or whether the charge operation was successful or unsuccessful, among other information (e.g., date, SOC of the EV 104 prior to charging, and duration of the charge). In one form, referring to FIG. 4, the depot control system 106 includes a depot communication module 402, a charge operation history module 404, and a charge operation module 406.

The depot communication module 402 is configured to communicate with external devices/systems (e.g., the EVSEs 102, the EV 104, and/or a portable computing device associated with the operator 108) via wireless/wired communication. In a non-limiting example, the depot communication module 402 includes communication devices such as, but not limited to: a router, a modem, an antenna(s), an input-output interface, a universal serial bus (USB) port, and/or other suitable devices for supporting wireless and wired communication.

The charge operation history module 404 is configured to store information related to the charge operations being performed at the charge depot 100. In a non-limiting example, the charge operation history module 404 is configured generate and update historical charge records to be stored in a depot charge records datastore 408. A historical charge record may be provided for each EVSE 102, each operator 108, and, in some variations, each EV 104.

In one form, each charge operation employs an EVSE 102, an operator 108, and an EV 104, which may be referred to as variables that influence the charge operation and potential cause of the plug-in error. The historical charge records maybe configured in various suitable ways to easily associate the three variables with each other for the charge operations. In a non-limiting example, the historical charge record for a selected EVSE 102 may include identification information related to the operator 108 and the EV 104 for each charge operation, and whether the charge was a success or included an error event (e.g., a plug-in error). Accordingly, the historical charge record for a selected operator includes identification information related to the EVSE 102 and the EV 104 for each charge operation, and the historical charge record for a selected EV includes identification information related to the EVSE 102 and the operator 108 for each charge operation.

The charge operation module 406 is configured to control and manage charge operations of the EVSE 102 and EVs 106 from tracking availability of the EVSE 102, directing an incoming EV 106 to a designated EVSE 102 for charging, and monitoring charge operation based on data from the EVSE 102, the EV 104, and/or the portable computing device associated with the operator 108. In a non-limiting example, the charge operation module 406 is operable as an EVSE monitor 410 and an EVSE-operator scheduler 412.

In one form, the EVSE monitor 410 is configured to store EVSE information related to each EVSE 102 in association with the operation state of each EVSE 102. In a non-limiting example, the EVSE information may include a location of the EVSE 102, a unique identification associated with the EVSE 102, the type of EVSE connector 308 provided with the EVSE 102, and/or a maintenance schedule of the EVSE 102. In addition, the operation state of the EVSE 102 may include: a stand-by state indicating the EVSE 102 is available to perform a charge operation; a charge in-progress state indicating that the EVSE 102 is in process of charging an assigned EV 104; a charge error state indicating that electrical power is not being transferred to the EV 106 even though no system/device level error is detected by the EVSE 102; and/or an off-line operation state indicating the EVSE 102 is unavailable for charging due to, for example, maintenance or needs repair.

The EVSE-operator scheduler 412 is configured to assign the EV 106 to an EVSE 102 based on the type of charge port 210 (also referred to as charge port type), the type of EVSE connector 308, and if available, a charge history for the EVs 106, the EVSEs 102, and/or the operator 108. For example, when the EV 106 enters the charge depot 100, the depot control system 106 may transmit a message to the EV 106 requesting charge state information for performing the charge operation, such as the charge port type and SOC of the battery pack 204. In another example, when the EV 104 enters the charge depot 100, the operator 108 obtains charge state information from the EV 104 by, for example, entering it manually via the portable computing device, connecting a dongle to the EV 104, among other methods.

Once obtained, the charge state information is provided to the depot control system 106. The EVSE-operator scheduler 412 selects a designated EVSE 102 from among available EVSEs 102 of the plurality of EVSE 102, where the available EVSEs 102 may include EVSEs 102 that are in a stand-by operation state and have an EVSE connector 308 that is compatible with the type of charge port 210 on the EV 106. The EVSE-operator scheduler 412 may employ one or more rules for selecting the designated EVSE 102 when there are multiple available EVSEs 102 for the EV 106. For example, the EVSE-operator scheduler 412 selects the first available EVSE 102, selects the available EVSE based on location of the available EVSEs 102 and/or the state of charge of the EV 106.

In the event there are multiple operators 108 at the charge depot 100, the EVSE-operator scheduler 412 is configured to assign an operator 108 based on the availability of the operator 108, and if available the charge history associated with the operator 108. In a non-limiting example, the EVSE-operator scheduler 412 tracks the operators 108 at the depot 100 and whether the operators 108 are checked-in to an EVSE 102 for connecting the EVSE 102 to the EV 104. Accordingly, the EVSE-operator scheduler 412, selects an operator from among one or more operators 108 that are not associated with an EVSE (e.g., are not checked-in or signed in to an EVSE 102 for performing a charge operation).

With the charge history provided in the depot charge records 408, the EVSE-operator scheduler 412 is configured to review charge records associated with at least one of the EV 106, the available EVSEs 102, or available operator(s) 108. As detailed below, the charge history provides information of successful and/or unsuccessful charge operation(s). In a non-limiting example, if charge history is available for the operator 108, the EVSE-operator scheduler 412 is configured to evaluate the number of unsuccessful charge operation associated between the operator 108 and one or more EVSEs 102 from among the plurality of EVSE 102. The EVSE-operator scheduler 412 selects the EVSE 102 having a lower unsuccessful charger operation than at least one of the other EVSE 102 for the operator 108. In yet another example, if the charge history is available for the EV 104 to be charged, the EVSE-operator scheduler 412 selects the available EVSE 102 that is not associated with a previous unsuccessful charge operation or has a lower number of unsuccessful charge operations than another available EVSE 102. Accordingly, the EVSE-operator scheduler 412 selects the EVSE 102 and/or the operator 108 that may provide a lower chance of an unsuccessful charge operation.

Once the EVSE 102 and/or the operator 108 are selected, the EVSE-operator scheduler 412 notifies the selected EVSE 102 and the operator 108. In a non-limiting example, the EVSE-operator scheduler 412 generates charge assignment messages to be transmitted the selected EVSE 102 and provided to the operator 108 via a portable computing device associated with the operator 108, a monitor that displays the assignment indicating the EV 104 and EVSE 102 assigned to the operator 108.

In some application, the EVSE-operator scheduler 412 may further transmit a charge instruction to the EV 104 to provide the selected EVSE 102 to perform the charge operation. The instructions may include the unique identification associated with the EVSE 102 and a map/instructions for locating the EVSE 102. In a non-limiting example, if the EV 104 is a fully-autonomous vehicle, the EV 104 may autonomously move to the selected EVSE 102, where the operator 108 then connects the EVSE 102 to the EV 104. In another example, if the EVSE 102 is not a fully-autonomous vehicle, the operator 108 (e.g., the operator 108 selected for the charge operation or another operator 108) or the original driver of the EV 104 drives the EV 104 to the EVSE 102.

With the EV 104 at the selected EVSE 102, the selected operator 108 may sign-in to the EVSE 102 and connect the EVSE connector 308 to the charge port 210. In some instances, the EVSE connector 308 may not be properly connected to the charge port 210 of the EV 104 and thus, electric power may not be provided to the battery pack 204 of the EV 104. In a non-limiting example, the plug-in error may be detected by the EVSE 102 when the EVSE connector 308 is disconnected from the EVSE 102 and has not connected to the charge port 210 within a selected time period, where the connection is detected using known techniques. In another example, the plug-in error is detected based on an error inputted by the operator 108. In some applications, the EVSE 102 may issue notification to the depot control system 106 indicating plug-in error. In addition to the depot control system 106, the EVSE 102 may immediately provide a notification on the HMI 304 to notify the operator 108 of the error.

If there is no error and the charge operation is completed, the charge operation history module 404 updates the historical charge records for the respective selected EVSE 102, operator 108, and if applicable the EV 104. In a non-limiting example, the charge operation history module 404 includes information indicating that the combination of the selected EVSE 102, the selected operator, and the EV 104 is successful.

In one form, the EVSE-operator scheduler 412 includes a charge error diagnosis 414 that is configured to diagnosis a potential cause of the plug-in error using, for example, information related to the EV 104 being charged, the selected EVSE 102, and/or the operator 108 as provided in the depot charge record datastore 408.

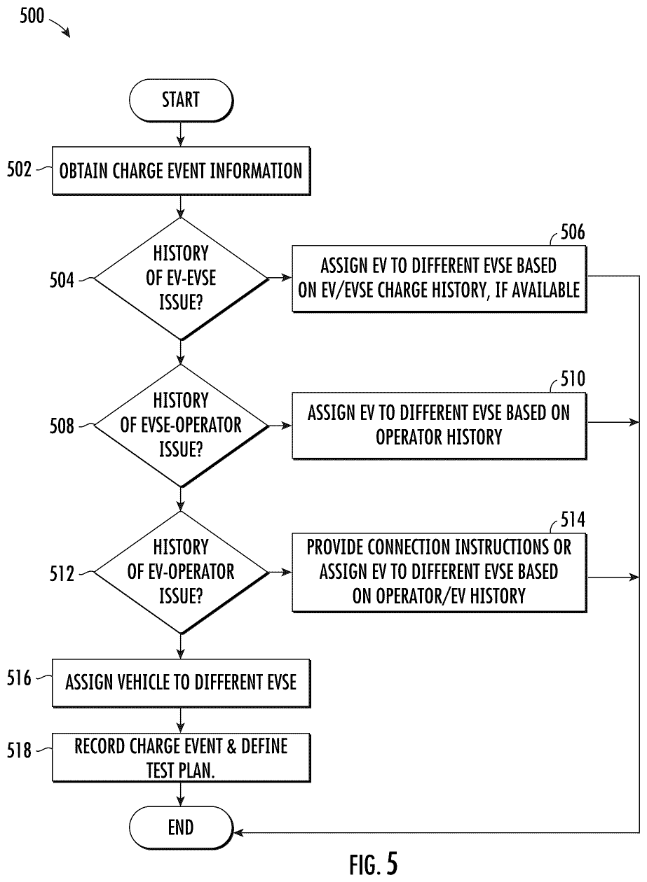

In a non-limiting example, FIG. 5 provides an example charge error diagnosis routine 500 for the charge error diagnosis 414. At operation 502, the charge error diagnosis 414 obtains charge event information related to the charge operation including, but not limited to: identification associated with the EVSE 102, the operator 108, and the EV 104 being charged; date of charge operation; time of the plug-in error detection; state of charge of the EV; and/or external factors (e.g., weather information, possible communication network outage information, and/or power outage information).

With the charge event information, the charge error diagnosis 414 determines if the EV 104 and the selected EVSE 102 have previous charge operation history, at operation 504. In a non-limiting example, using the charge event information and historical charge records (e.g., a record associated with the EVSE 102 and/or the EV 104), the charge error diagnosis 414 determines if the selected EVSE 102 has an unsuccessful charge operation, with the EV 104 from one or more previous charge operations.

If there is history between the EV 104 and the selected EVSE 102, the charge error diagnosis 414 recommends assigning the EV 104 to a different EVSE 102 based on the EV 104 or EVSE 102 charge history, at operation 506. In a non-limiting example, the charge error diagnosis 414 determines if there is at least one alternative EVSE 102 compatible with the EV 104 that has a successful charge operation with the EV 104 or an EVSE 102 that does not have a charge history with the EV 104. Using the one or more alternative EVSE 102, the EVSE-operator scheduler 412 selects an alternative EVSE 102 that is available for charging the EV 104, and provides a charge assignment message to the selected alternative EVSE 102. In some variations, the EVSE-operator scheduler 412 also provides a notification to the EVSE 102 having the charging issue indicating to the operator 108 that the EV 104 is to be charged at the selected alternative EVSE 102.

If there is no history between the selected EVSE 102 and the EV 104, the charge error diagnosis 414, determines, at 508, if the selected EVSE and the operator 108 have a previous charge history. In a non-limiting example, using the charge event information and historical charge records (e.g., a record associated with the EVSE 102 and/or the operator 108), the charge error diagnosis 414 determines if the selected EVSE 102 has an unsuccessful charge operation with the operator 108 from one or more previous charge operations.

If there is history between the selected EVSE 102 and the operator 108, the charge error diagnosis 414 recommends assigning the EV 104 to a different EVSE 102 based on the operator 108/EVSE 102 history, at operation 510. In a non-limiting example, the charge error diagnosis 414 determines if there is at least one alternative EVSE 102 compatible with the EV 104 that has a successful charge operation with the operator 108 or does not have a charge history with the operator 108. Using the one or more alternative EVSE 102, the EVSE-operator scheduler 412 selects an alternative EVSE 102 that is available for charging the EV 104, and provides a charge assignment to the selected alternative EVSE 102 and/or the operator 108. In some variations, the EVSE-operator scheduler 412 also provides a notification to the EVSE 104 having the charging issue indicating to the operator 108 that the EV 104 is to be charged at the selected alternative EVSE 102.

If there is no history between the selected EVSE 102 and the operator 108, the charge error diagnosis 414, determines, at 512, if the EV 104 and the operator 108 have a previous charge history. In a non-limiting example, using the charge event information and historical charge records (e.g., a record associated with the operator 108 and/or the EV 104), the charge error diagnosis 414 determines if the operator 108 has an unsuccessful charge operation with the EV 104 from one or more previous charge operations.

If there is an unsuccessful charge history between the operator 108 and the EV 104, the charge error diagnosis 414, at operation 514, assist the operator 108 or may request assistance from another operator 108. In a non-limiting example, the charge error diagnosis 414 provide instructions to the operator 108 on how to connect the selected EVSE 102 to the EV 104 via the HMI 304, where the instructions for operating the EVSE 102 may be stored by the EVSE 102. In addition to or in lieu of providing instructions, the charge error diagnosis 414 is configured to notify another operator 108 that does not have an unsuccessful charge operation with the EV 104 and, if available, does not have an unsuccessful charge operation with the selected EVSE 102. At operation 514, the charge error diagnosis 414 may assign a different EVSE based on the history of the operator 108 and/or the EV 104.

If there is no history between the EV 104 and the operator 108, the charge error diagnosis 414, at operation 516, has the EVSE-operator scheduler 412 select another available EVSE 102 to perform the charge operation. With no association detected between different combination of the EVSE 102, the operator 108, and the EV 104, a different EVSE 102 is selected so as to avoid further delay of the charge operation. In addition, at operation 518, the charge error diagnosis 414 records the new charge event having the plug-in error via the charge operation history module 406. As detailed above, the charge operation history module 406 is configured to record the charge event information with records associated with the EVSE 104, the operator 108, and/or the EV 104.

In some application, at operation 518, the charge error diagnosis 414 is configured to define a test plan for the new charge event by defining a plurality of subsequent charge operations for the EV 104, the operator 108, and the EVSE 102 to build a charge operation history that may be used to identify one or more causes of the plug-in error. Stated differently, if the EVSE 102, the EV 104, and the operator 108 are considered variables to the plug-in error charge event, the test plan is defined to change at least one of the variables for a subsequent charge operation. In a non-limiting example, the subsequent charge operations for the test plan includes: one or more other EVSEs 102 among the plurality of EVSEs 102 being assigned to charge the EV 104 and with the operator; the operator 108 being assigned to charge one or more different EVs among the one or more EVs with the selected EVSE 102; or the EVSE 102 being assigned to charge the EV 104 using different operators. Accordingly, the EVSE-operator scheduler 412 is configured to further selected the EVSE 102 and/or the operator 108 based on the test plan for the EV 104, if available.

It should be readily understood that the charge error diagnosis 414 may be configured in various suitable ways, and should not be limited to the example provided herein. The following examples of the charge error diagnosis 414 may be incorporated or in combination with one another.

In some variations, the charge error diagnosis 414 is configured to track the number of plug-in attempts made for the EV 104. Accordingly, in lieu of assigning the EV 104 to a different EVSE 104 after a first plug-in error due to the operator 108 or the EVSE 102, the charge error diagnosis 414 may be configured to provide instructions to the operator 108 on how to connect the selected EVSE 102 to the EV 104 via the HMI 304. If a plug-in error still occurs, an alternative EVSE 102 is then assigned to the EV 104.

In another variation, the charge error diagnosis 414 is configured to recommend training to the operator 108 if the operator 108 has a history of plug-in errors.

In yet another variation, the charge error diagnosis 414 is configured to determine if the plug-in error is caused by a system error of the EVSE 102 or the EV 104. That is, the EVSE 102 and/or the EV 104 may have a hardware or software issue that is preventing the battery pack 204 from being charged, and thus, may not be an issue with actual connection between the EVSE connector 308 and the charge port 210. Possible system error(s) may be reported by the respective EVSE 102 or EV 104 either automatically or after inquiry by the depot control system 106.

In one variation, the charge error diagnosis 414 may be configured to record the charge event, but may not generate a charge schedule.

In another variation, the charge error diagnosis 414 may only evaluate previous charge history associated with the operator 108 (e.g., only operations 508 and 512 of FIG. 5).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium (e.g., non-transitory computer-readable storage medium). The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a USB, CD, a DVD, or a Blu-ray Disc).

The apparatuses and methods described in this application may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A control system for controlling charge operation of an electric vehicle (EV) using a plurality of electric vehicle supply equipment (EVSEs), comprising:
a processor programmed to generate a first charge message to assign a first EVSE to perform a charge operation for the EV, and generate a second charge message to assign a second EVSE to perform the charge operation for the EV such that the second EVSE performs the charge operation in response to the first EVSE being unsuccessful in charging the EV after a plug-in attempt by an operator and a previous charge operation having an unsuccessful charge with an operation combination including the operator, the EV, or the first EVSE.

2. The control system of claim 1, wherein the operation combination includes:
the operator having an unsuccessful charge operation associated with the first EVSE,
the first EVSE having an unsuccessful charge operation associated with the EV, or the operator having an unsuccessful charge operation associated with the EV.

3. The control system of claim 2, wherein prior to generating the second charge message, the processor is further programmed to provide connection instructions to connect the first EVSE to the EV in response to the previous charge operation including the operator having an unsuccessful charge operation associated with the EV as the operation combination.

4. The control system of claim 1, wherein the processor is further programmed to select the second EVSE in response to:
the second EVSE having a lower unsuccessful charge operation for the operator than that of the other EVSE, or
the second EVSE having a lower unsuccessful charge operation for the EV than that of the other EVSE.

5. The control system of claim 1, wherein the processor is further programmed to store identification data related to the EV, the first EVSE, and the operator in association with one another in response to the first EVSE being unsuccessful in charging the EV after the plug-in attempt.

6. The control system of claim 1, wherein the processor is further programmed to select the first EVSE based on a historical charge operation record indicating:
the first EVSE or the operator having not participated in a charge operation with the EV,
the EV having one or more successful charge operations with the first EVSE, or
the operator having successful charge operations with the first EVSE.

7. The control system of claim 1, wherein the plug-in attempt is a first plug-in attempt by the operator, and the processor is further programmed to generate the second charge message in response to the first plug-in attempt being unsuccessful.

8. The control system of claim 1, further comprising a communication device configured to communicate with the plurality of EVSEs including transmitting a charge message to a selected EVSE, wherein the charge message includes the first charge message and the second charge message.

9. A non-transitory computer-readable storage medium comprising programming instructions that are configured to cause a processor to control charge operation of an electric vehicle (EV) in a charge depot, wherein the programming instructions comprise instructions to:
instruct a second electric vehicle supply equipment (EVSE) to perform a charge operation for the EV in response to a first EVSE being unsuccessful in charging the EV and an operator having an unsuccessful charge operation associated with the first EVSE, the first EVSE having an unsuccessful charge operation associated with the EV, or the operator having an unsuccessful charge operation associated with the EV.

10. The non-transitory computer-readable storage medium of claim 9, wherein the programming instructions further comprise instructions to, prior to instructing the second EVSE, provide connection instructions to connect the first EVSE to the EV in response to the operator having an unsuccessful charge operation associated with the EV.

11. The non-transitory computer-readable storage medium of claim 9, wherein the programming instructions further comprise instructions to select the second EVSE in response to the second EVSE having a lower unsuccessful charge operation for the operator than that of the other EVSE, or the second EVSE having a lower unsuccessful charge operation for the EV than that of the other EVSE.

12. The non-transitory computer-readable storage medium of claim 9, wherein the programming instructions further comprise instructions to store identification data related to the EV, the first EVSE, and the operator in association with one another in response to the first EVSE being unsuccessful in charging the EV.

13. The non-transitory computer-readable storage medium of claim 9, wherein the programming instructions further comprise instructions to select the first EVSE based on a historical charge operation record indicating the first EVSE or the operator having not participated in a charge operation with the EV, the EV having one or more successful charge operations with the first EVSE, or the operator having successful charge operations with the first EVSE.

14. The non-transitory computer-readable storage medium of claim 9, wherein the second EVSE is instructed in response to a first plug-in attempt being unsuccessful.

15. A method for controlling a charge operation of an electric vehicle (EV) at a charge depot having a plurality of electric vehicle supply equipment (EVSEs), comprising:
transmitting a first charge message to assign a first EVSE to perform a charge operation for the EV;
transmitting a second charge message to assign a second EVSE to perform the charge operation for the EV such that the second EVSE performs the charge operation in response to the first EVSE being unsuccessful in charging the EV after a plug-in attempt by an operator and a previous charge operation having an unsuccessful charge operation associated with the EV or first EVSE, or the first EVSE having an unsuccessful charge operation associated with the EV.

16. The method of claim 15, further comprising, prior to transmitting the second charge message, transmitting connection instructions to connect the first EVSE to the EV in response to the previous charge operation including the operator having an unsuccessful charge operation associated with the EV, wherein the second charge message is transmitted after a second plug-in attempt in response to providing connection instructions.

17. The method of claim 15, further comprising selecting the second EVSE in response to:
the second EVSE having a lower unsuccessful charge operation for the operator than that of the other EVSE, or
the second EVSE having a lower unsuccessful charge operation for the EV than that of the other EVSE.

18. The method of claim 15, further comprising storing identification data related to the EV, the first EVSE, and the operator in association with one another in response to the first EVSE being unsuccessful in charging the EV after the plug-in attempt.

19. The method of claim 15, further comprising selecting the first EVSE based on a historical charge operation record indicating:
the first EVSE or the operator having not participated in a charge operation with the EV,
the EV having one or more successful charge operations with the first EVSE, or
the operator having successful charge operations with the first EVSE.

20. The method of claim 15, wherein the plug-in attempt is a first plug-in attempt by the operator, and the second charge message is transmitted in response to the first plug-in attempt being unsuccessful.
